(19) United States
(12) Patent Application Publication
(10) Pub. No.: US 2007/0053341 A1
(43) Pub. Date: Mar. 8, 2007

(54) System and method for synchronizing companion electronic devices

(76) Inventor: Ronald S. Lizzi, Bethany, CT (US)

Correspondence Address: Arthur G. Schaier;Carmody & Torrance LLP, 50 Leavenworth Street, P.O. Box 1110, Waterbury, CT, 06721-1110, US

(21) Appl. No.: 11/220,748

(22) Filed: Sep. 6, 2005

(51) Int. Cl. H04J 3/06

(52) U.S. Cl. 370/350; 370/503

(57) ABSTRACT

A method of establishing a communication link between a receiving device and a transmitting device from among a plurality of transmitting devices, wherein the preferred criterion for selection of the preferred transmitting device is based upon how long the particular transmitting device has been active.

### BACKGROUND OF THE INVENTION

The present invention is directed to a system and method for synchronizing transmitting and receiving (i.e. companion) devices, and in particular, to a novel system and methodology that uses, as a criterion for synchronization, the length of time that the transmitting device has been active.

Synchronization allows the receiver of the receiving device to be turned on only for the duration of the companion device's transmission, thus conserving power in the receiving device and eliminating the processing of transmissions from devices other than the companion device.

Wireless companion devices, such as a heart rate monitor (e.g. the transmitting device) and a wristworn device (e.g. the receiving device), are very popular in a variety of environments, most notably in the exercise, coaching, athletic and/or teaching endeavors, just to name a few.

By way of example, one of the most popular heart rate monitoring arrangements comprise a transmitter device that is preferably (but not necessarily) worn about one's chest and a corresponding receiver, which is also worn about the user, preferably about the wrist. Timex Corporation is but one leading manufacturer of such arrangements.

One of the perceived concerns when designing such arrangements is to ensure the synchronization of a desired transmitter (e.g. heart rate) with a desired receiver. That is, it is a perceived disadvantage if two side-by-side individuals (e.g. in an exercise room, for example) cannot be assured that their respective receivers are in synchronization with their own transmitting devices. More particularly, it is desirable to ensure that upon an individual's entering of such an environment for the first time and upon turning on her heart rate monitor, that her receiving (e.g. wristwom) device will synchronize with her heart rate monitor, and no other.

Specifically, in those most popular physiological (e.g. heart rate) monitor arrangements using wireless data transmission from the sensor/transmitter (e.g. chest) unit to the display (e.g. wrist worn) unit, it is important to reduce or eliminate interference that may occur when a person wearing a heart monitor is in close proximity to another person wearing another similarly configured heart rate monitor.

Presently, there are at least two known methods that address this concern. The first method utilizes a receiver that synchronizes with the transmitter from which it receives the strongest signal. That is, in this methodology, an assumption is made is that the transmitter closest to the receiver (and therefore presumably having the strongest signal) is the transmitter of the particular user, and therefore the correct one to which the receiving device should synchronize. The second method utilizes an identification byte that is transmitted by the transmitter, with the companion receiver only being able to synchronize with the transmitter that is transmitting the anticipated identification byte. Perceived limitations exist in each of these 10 two methods. For example, in the first described method, if the strongest signal being received by the receiving device is not from the desired transmitter, the receiving device may synchronize itself with the wrong transmitting device. In the latter method, the receiving device may be limited in the number (or type) of transmitting devices with which it can synchronize.

Therefore, it is believed that further advances in the art are desirable. The present invention overcomes the perceived deficiencies in the prior art and provides the advantages disclosed herein.

### SUMMARY AND OBJECTIVES OF THE INVENTION

It is thus an objective of the present invention to overcome the perceived deficiencies in the prior art.

In particular, it is an objective of the present invention to provide a novel arrangement and methodology for reliably synchronizing companion devices, and in particular a transmitting device and a receiving device.

It is another objective of the present invention to provide such an arrangement and methodology to monitor and display measurable physiological parameter(s) of a user.

It is yet another objective of the present invention to provide the foregoing arrangement and methodology in an electronic device/biomedical sensing device combination in which signals from the biomedical sensing devices are transmitted wirelessly to the receiving device. In a preferred embodiment, the sensing device is a heart rate monitor.

It is still another objective of the present invention to provide a novel system and methodology that uses, as a criterion for synchronization, the length of time that the transmitting device has been active.

Further objects and advantages of this invention will become more apparent from a consideration of the drawings and ensuing description.

The invention accordingly comprises the features of construction, combination of elements, arrangement of parts and sequence of steps which will be exemplified in the construction, illustration and description hereinafter set forth, and the scope of the invention will be indicated in the claims.

Generally speaking, the present invention is directed to a method of establishing a communication link between a transmitting device from among a plurality of transmitting devices and a receiving device, wherein each of the transmitting devices comprise a transmitter that respectively transmit packets of information, each packet of information comprising a value that is indicative of how long the particular transmitter device has been active, and wherein the receiving device receives transmitted packets of information from one or more of the transmitting devices and processes the respectively received values, wherein the method comprises the steps of receiving, during a first transmission period, a first packet of information transmitted from a first transmitting device; receiving, during a later transmission period, a second packet of information from a transmitting device and determining from the value transmitted with the second packet of information whether the transmitting device has been active for no longer a period of time than the transmitting device from which the first packet of information was received during the first transmission period; and if so, synchronizing the receiving device with the transmitting device that transmitted the second packet of information.

In a particular preferred embodiment, a method of establishing a communication link between a receiving device and a transmitting device from among at least a first transmitting device and a second transmitting device is provided, wherein each of the first and second transmitting devices comprise a transmitter that respectively transmit packets of information, each packet of information comprising a value that is indicative of how long the particular transmitting device has been active, and wherein the receiving device receives transmitted packets of information from at least the first and second transmitting devices and processes the respectively received values. This preferred method comprises the steps of receiving, during a first transmission period, a first packet of information transmitted from the first transmitting device and a first packet of information from the second transmitting device and maintaining the value associated with the transmitting device that has been active for the shortest period of time; receiving, during a later transmission period, a packet of information from one or more transmitting devices; and determining, from the respective values transmitted with the packets of information from the one or more transmitting devices during the later transmission period, which transmitting device from those transmitting devices for which packets of information have been received and processed, has been active for the shortest period of time; and synchronizing the receiving device with the transmitting device that transmitted the packet of information with the value indicative of having been active for the shortest period of time.

In yet another preferred embodiment, a method of establishing a communication link between a receiving device and a transmitting device from among a first transmitting device and at least a second transmitting device is provided, wherein each of the transmitting devices comprise a transmitter that respectively transmit packets of information, each packet of information comprising a value that is indicative of how long the particular transmitter device has been active, and wherein the receiving device receives transmitted packets of information from at least the first and second transmitting devices and processes the respectively received values. This embodiment comprises the steps of receiving respective first packets of information transmitted from the first and at least second transmitting devices; determining from the values transmitted with the respective first packets of information which transmitting device has been active for the shortest period of time; and maintaining synchronization of the receiving device with the transmitting device determined to have been active for the shortest period of time. In a particular methodology of this embodiment, included may be the steps of receiving, during a predetermined transmission period, a first packet of information transmitted from the first transmitting device; receiving, but prior to receiving a second packet of information from the first transmitting device, a first packet of information from the second transmitting device and determining that the second transmitter has been active for a shorter period of time than the first transmitting device; determining that no other packets of information received prior to receiving a second packet of information from the second transmitting device has a value indicative of a transmitting device having been active for a shorter period of time than the second transmitting device; and maintaining synchronization of the receiving device with the second transmitting device. In another particular sequence of steps the method may comprise receiving, during a predetermined transmission period, a first packet of information transmitted from the first transmitting device; receiving, but prior to receiving a second packet of information from the first transmitting device, a first packet of information from the second transmitting device and determining that the second transmitter has been active for a period of time longer than the first transmitting device; determining that no other packets of information received prior to receiving a second packet of information from the first transmitting device has a value indicative of a transmitting device having been active for a shorter period of time than the first transmitting device; and maintaining synchronization of the receiving device with the first transmitting device.

In a particular embodiment, the transmitting devices are transmitting heart rate information.

An arrangement that carries out the foregoing method is also contemplated hereby.

### BRIEF DESCRIPTION OF THE DRAWINGS

For a fuller understanding of the invention, reference is had to the following description taken in connection with the accompanying figures, in which:

FIG. 1A is a flowchart illustrating an overall preferred methodology of the present invention in accordance with a first embodiment;

FIG. 1B is a flowchart illustrating a preferred sequence of steps by which the receiving device initiates selection with a particular transmitting device in accordance with the first embodiment;

FIG. 1C is a flowchart illustrating a preferred sequence of steps for receiving periodic communications from the transmitting device with which the receiving device is synchronized, all in accordance with both the first and second embodiments of the present invention; and

FIG. 2A is a flowchart illustrating an overall preferred methodology of the present invention in accordance with a second embodiment.

### DETAILED DESCRIPTION OF THE PREFERRED EMBODIMENTS

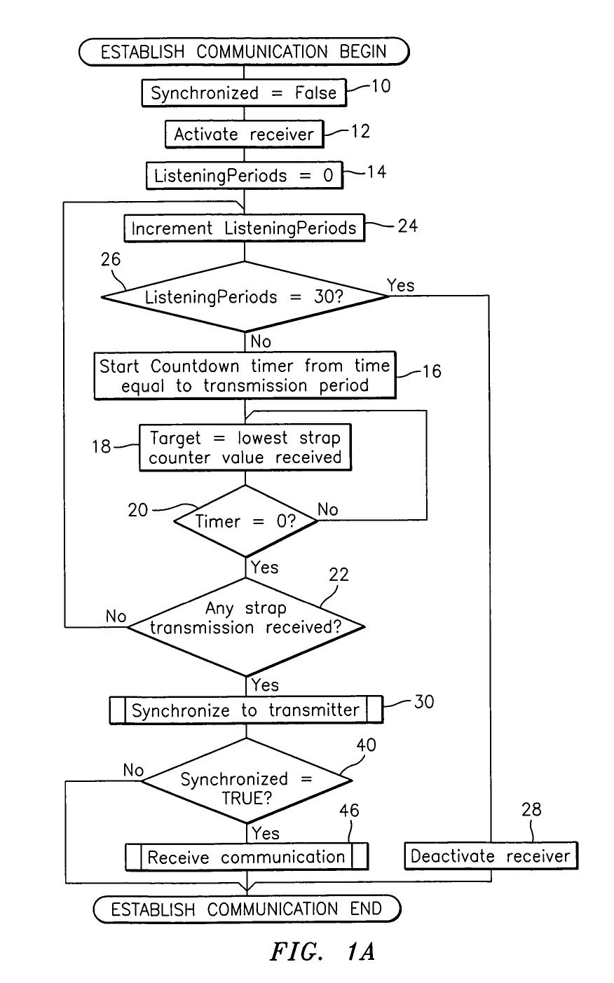

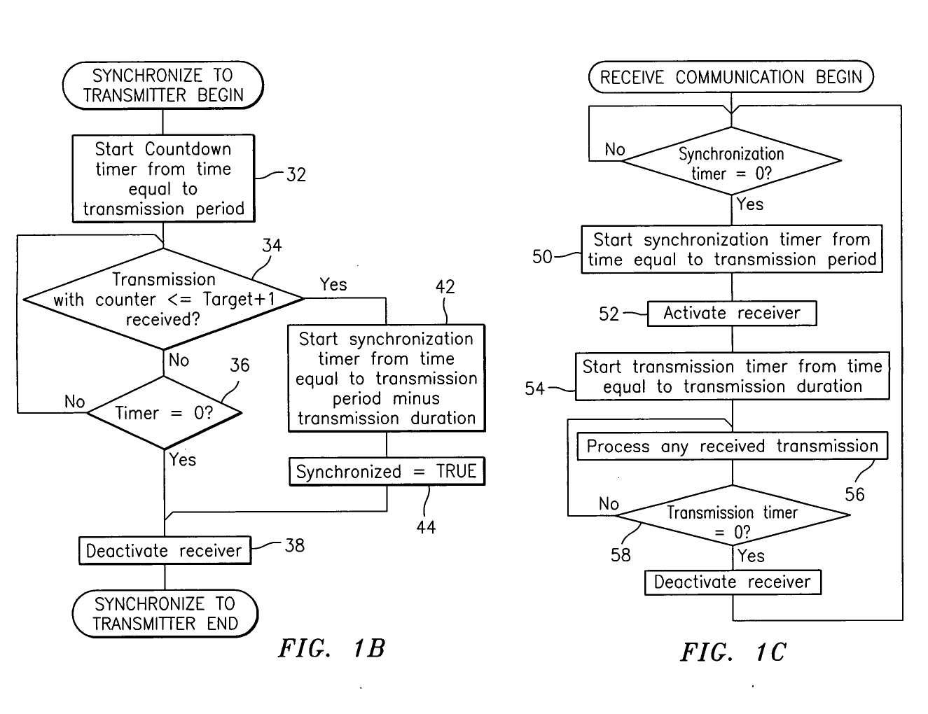

FIGS. 1A, 1B and 1C illustrate a preferred method of carrying out the present invention of establishing a communication link between a transmitting device (e.g. from among a plurality of transmitting devices) and a receiving device in accordance with a first embodiment.

However, prior to turning to the specifics of the present invention, it is important to disclose the preferred transmission protocol of packets of information from each of the respective transmitting devices. In the preferred embodiment, each transmitting device is a biomedical sensing device, and a heart rate monitor in particular. However, other transmitting (i.e. biomedical sensing) devices, such as those transmitting information relating to one's blood pressure and/or oxygen level are contemplated herein and are intended to be covered by the generic use herein of the phrases “transmitting device” or “biomedical sensing device” or the like.

As would be understood by one ordinarily skilled in the art, there are at least several methodologies for generally transmitting the sensed data relating to the physiological parameter from a sensing device to its associated receiving (e.g. wristwom) device.

In the preferred embodiment, each biomedical sensing device transmits a packet of data in regular intervals (e.g. every two (2) seconds). With this transmission methodology, the transmission rate is independent of the actual heart rate that the respective sensing device is measuring. Once the receiving device synchronizes with the desired transmitting device, the receiving device is configured to know that every regular interval thereafter (e.g. the aforementioned two (2) seconds), another information packet will be transmitted (and presumably from the sensing device to which the receiving device just synchronized).

In accordance with the present invention, each packet of information transmitted by a heart rate transmitting device comprises at least the heart rate data (e.g. 137 beats/minute) and a count value. In its most simplistic form, the count value is preferably a value that increments from 0 to 255, although smaller (and larger) minimum and/or maximum values are contemplated herein. In the preferred embodiment, upon “power up” (i.e. activation (i.e. becoming “active”)) the transmitting device begins to transmit packets of information comprising the aforementioned heart rate (and, if the sensing device provided therewith is not actually detecting any heart rate, the heart rate data value may 0 beats/minute) and the count value. Preferably, upon “power up” the value of the count value associated with the first transmitted packet of information is a minimum (e.g. “0”). Importantly, each successive transmission of a packet of information has a count value that has been incremented, preferably in increments of one (1). That is, each successively transmitted packet of information from a particular transmitter preferably has a count value that is greater than the count value associated with a previously transmitted packet of information from that particular transmitter. Upon reaching the predetermined maximum value however, there is no rollover of the count value counter, which thus avoids a later count value of a previously transmitting device to be less than a newly “powered up” transmitting device. However, upon each “power up” of a transmitting device, the count value again begins at its minimum value. With such a protocol, a properly configured receiving device can discern (as it relates to those transmitting devices that the receiving device can “hear”) which transmitting device most recently “powered up.” In other words, the count value is indicative of how long the particular transmitter device has been active. And, in a preferred embodiment of the present invention, it is desirable for the receiving device to synchronize with the transmitting device that most recently “powered up” since it is a good assumption that the transmitting device that most recently “powered up” is that transmitting device most likely associated with the particular receiving device.

What follows is a disclosure of the preferred synchronization methodologies. However, for completeness, it should then be understood that as soon as the receiving device selects the transmitting device to which it will synchronize, its time of reception (e.g. relative to an internal timer) of a selected packet of information is recorded and the electronic device enters its synchronization mode. In the synchronization mode, the receiver in the electronic device can then be “shut off” essentially until it expects to receive the next information packet (e.g. two (2) seconds later). At that point, the receiver in the electronic device preferably turns on just in time to catch the next packet from (presumably) the same transmitter. This process is then repeated every transmission period (e.g. every two (2) seconds) to obtain the next information packet containing the heart rate (or other physiological parameter) sensed, as well as the count value.

For completeness, it should be understood that the preferred biomedical sensing device comprises a physiological parameter sensor coupled to an amplifier, which when detecting heartbeats, is preferably an ECG amplifier, which itself is operatively coupled to a microcontroller for processing the amplified ECG signal. The signal, once processed and properly formatted in accordance with the aforementioned protocol, is then transmitted by a receiver, which itself is operatively coupled to the microcontroller.

Turning now to the particulars of the first embodiment of the present invention illustrated in FIGS. 1A to 1C, the preferred method of synchronization begins with a listening period, wherein the receiving device will “listen” for one or more transmitting devices. The initial steps in this methodology preferably comprise clearing a “synchronization” flag (step 10), activating the receiving device to its “listening mode” (step 12) and initializing the listening period counter (step 14). Clearly, the ordering of the foregoing steps is not material to the present invention.

During the first listening period, the receiving unit will start a timer (step 16), which can be either a count-up or count-down timer, the duration of which is preferably equal to the expected transmission period between transmissions of packets of information in accordance with the preferred protocol set forth above, namely two (2) seconds. During this two (2) second period, the receiving device is “listening” for any and all the transmitting devices it is capable (e.g. signal strength) of hearing. Moreover, the receiving device is keeping track of all the count values associated with each respective packet of information it receives and processes (step 18). Still further, by virtue of the timer being set to the transmission period and no longer, the receiving device is assured of not receiving, during this first transmission period, successive (e.g. two) packets of information from the same transmitting device. In step 18, the receiving device is maintaining the lowest count value determined from the count value associated with the each respective packet of information transmitted from the one or more transmitting devices. Clearly, one skilled in the art would appreciate that step 18 may itself comprise a plurality of substeps comprising a check of whether any transmissions are received, a determination step to check if the received count value is the lowest (or greatest in a count-down implementation) received, and an updating of the target value (i.e. being equal to the newly determined lowest count value). As illustrated, the receiving device listens for any transmitting devices for the entire first transmission period (step 20).

For example, assume an individual enters a room, having with her a first transmitting device and a companion-receiving device, and that the steps by which the receiving device acquires the packets of information from the first transmitting device in anticipation of synchronization therewith has not yet occurs. And further, assume that already in the room is another individual whose (similarly configured) transmitting device has already been transmitting for sixty (60) seconds. Upon entry into the room and upon “power up” (i.e. activation), the count value transmitted with the first packet of information from the first transmitting device will be probably zero (or one), while the count value being transmitted by the other individual's transmitting device will be approximately 30. Further, assume that the receiving device associated with the first mentioned individual can “hear” and process the packets of information being transmitted by both transmitting devices. Notwithstanding all of the foregoing, the present invention provides a method to maximize the likelihood that the receiving device of the first mentioned individual will synchronize to the most recently “powered up” transmitting device (i.e. her own). The present invention achieves this by preferably synchronizing itself to the transmitting device transmitting the lowest count value during the transmission period provided in steps 18 and 20. That is during the transmission period, the receiving device is storing/maintaining the lowest count value received. At the end of the first transmission period (i.e. step 20) the receiving device determines if it has received any packets of information from any transmitting device (step 22). If the answer is in the negative, the methodology calls for the incrementing of the “listening period” counter at step 24, and the foregoing process is repeated for another transmission period (i.e. steps 16-20). If the receiving device does not hear any transmitting devices (step 22) for the entire listening period (e.g. 30 periods×2 seconds/transmission period=60 seconds), the preferred method results in the deactivation of the receiving device (steps 26, 28) and the termination of the routine.

On the other hand, as set forth above, if, during one of the listening periods, the receiving device heard at least one of the transmitting devices, the answer to the inquiry in step 22 is in the affirmative, and the methodology progresses to the synchronization subroutine set forth in FIG. 1B (step 30) and the receiving device maintains (e.g. in memory) the value of the count value of the packet of information transmitted by the transmitting device.

FIG. 1B illustrates the sequence of steps for selecting the most appropriate transmitting device with which it should synchronize. Specifically, at step 32, once again a timer is started to count down (or up) for the length of the transmission period (e.g. 2 seconds). During this transmission period, the receiving device is again listening for any and all transmitting devices transmitting respective packets of information. However, during this transmission period of FIG. 1B, the receiving device is specifically looking for a packet of information having a count value less than or equal to an incremented value of the lowest count value transmitted with the packets of information during the listening period in FIG. 1A. Preferably, the incremented value need only be one greater (i.e. +1) than the lowest count value received during the listening period in FIG. 1A since, in the simplest of examples, the receiving device will hear the same transmitting device it found to have the lowest count value in FIG. 1A, and based on the preferred protocol, the count value associated with the subsequent packet of information will be one unit greater (however, the phrases “incremented” is used to recognize that increments greater than (or less than) 1 unit are contemplated herein and within the scope of the present invention).

As illustrated in steps 34 and 36, if the receiving device does not hear any transmitting devices that are transmitting packets of information having associated count values that are less than or equal to an incremented value of the lowest count value received during steps 16-20, then the receiver is deactivated in step 38, and the process ends since the decision inquiry at step 40 is still “no.”

On the other hand, once the receiver receives a packet of information having a count value that is less than or equal to the incremented value of the lowest count value received during the listening period of FIG. 1A, the receiver will start a synchronization timer (step 42) from the time equal to the transmission period minus the transmission duration in order to be able to be ready to hear the particular transmitting device transmitting a successive (e.g. next) packet of information. The method proceeds to step 44 where the synchronization flag is “set” and the routine returns to step 40 where, if the synchronization flag has been set, the preferred methodology begins its “receive communication” (step 46) subroutine of FIG. 1C.

The flexibility of the present invention is specifically evident in the present invention's use of “looking” for a count value from a transmitting transmitter that is less than or equal to (as opposed to only equal to) the incremented count value. In this way, the present invention always allows for the receiver's synchronization with the transmitter having the lowest received count value. That is, in the scenario whereby the desired transmitter had not yet been turned on or could not otherwise be heard during the first transmission period, the “less than” parameter provides the receiver with a “second chance” to synchronize with presumably the most recently activated transmitter (i.e. with the lowest count value), even if first “heard” in the second transmission period.

FIG. 1C is the preferred subroutine to be utilized with the present invention, in which the receiving device maintains communication with the transmitting device having a count value less than or equal to the lowest count value determined in steps 16-20. Specifically, at step 50, once again a timer is started to count down (or up) for the length of the transmission period (e.g. 2 seconds) and the receiving device is activated (step 52). At step 54, another timer is started to count down (or up) for the length of the transmission duration (e.g. 50 milliseconds), and the receiving device is then listening (steps 56, 58). The receiving device shuts down until it expects to receive another transmission from the transmitting device to which it selected in FIG. 1B, at which point it begins the process (steps 50-58) again.

In summary, it can thus be seen that in the simplest of examples, the preferred methodology comprises the steps of receiving, during a first transmission period, a first packet of information transmitted from a first transmitting device; receiving, during a later (e.g. next successive) transmission period, a second packet of information from a transmitting device (which is most likely, but not necessarily, the same transmitting device) and determining whether the count value transmitted with the second packet of information is less than or equal to an incremented value (e.g. +1 value) of the count value transmitted with the first packet of information; and if so, synchronizing the receiving device with the transmitting device that transmitted the second packet of information. In the foregoing example, it is most likely that the second packet of information was also transmitted from the first transmitting device and thus, the receiving device synchronizes with the first transmitting device.

To even further appreciate the present invention, however, it will be recognized that there may exist in the listening area of interest at least a second transmitting device comprising a transmitter that is transmitting packets of information, again, each of which comprises a count value and wherein each successively transmitted packet of information from the transmitter of the second transmitting device has a count value that is greater than the count value associated with a previously transmitted packet of information. Here, the receiving device is receiving transmitted packets of information from at least the first transmitting device and the second transmitting device and processes the respectively received count values. In such an example, the method in accordance with the present invention comprises the steps of receiving, during the first transmission period, a first packet of information transmitted respectively from both the first and second transmitting device and maintaining the lowest count value determined from the count value associated with the respective first packets of information; receiving, during a later (e.g. next successive) transmission period, a packet of information from a transmitting device (which most likely is one of the first and second transmitting devices, but may in fact be yet a third transmitting device); and determining whether the count value transmitted with the packet of information from the transmitting device during the later transmission period is less than or equal to an incremented (or decremented in a count-down implementation) value of the lowest count value determined from the count value associated with the respective first packets of information; and if so, synchronizing the receiving device with the transmitting device that transmitted the packet of information during the later transmission period.

As set forth above, in this latest example, if, during the later transmission period, the receiving device processes a second packet of information transmitted by the first transmitting device and determines that the count value associated with the second packet of information is greater than the incremented value of the lowest count value determined from the count values associated with the first packets of information transmitted from the first and second transmitting devices, then the method comprises the steps of processing a second packet of information transmitted by the second transmitting device and determining whether the count value associated with the second packet of information from the second transmitting device is less than or equal to the incremented value of the lowest count value determined from the count value associated with the first packets of information, and if so the method comprises the steps synchronizing the receiving device with the second transmitting device.

However, if during the later transmission period, the receiving device processes the second packet of information transmitted by the first transmitting device and determines that the count value associated with the second packet of information is less than or equal to the incremented value of the lowest count value determined above, then the method comprises the steps of synchronizing the receiving device with the first transmitting device. In fact, the receiving device will select the first transmitting device that transmits a count value less than or equal to the stored lowest count value (that the receiving device “hears”).

And, if during the later transmission period the receiving device does not process a packet of information having a count value less than or equal to the incremented value of the lowest count value determined above, the method comprises the steps of inhibiting the synchronization of the receiving device with either of the first or second transmitting device during the later transmission period.

Reference will now be made to yet a second embodiment of the present invention. Generally speaking, this second embodiment is likewise directed to a method of establishing a communication link between a receiving device and a transmitting device from among a first transmitting device and at least a second transmitting device. In this second embodiment, the method comprises the steps of receiving respective first packets of information transmitted from the first and at least second transmitting devices; determining from the values transmitted with the respective first packets of information which transmitting device has been active for the shortest period of time; and maintaining synchronization of the receiving device with the transmitting device determined to have been active for the shortest period of time.

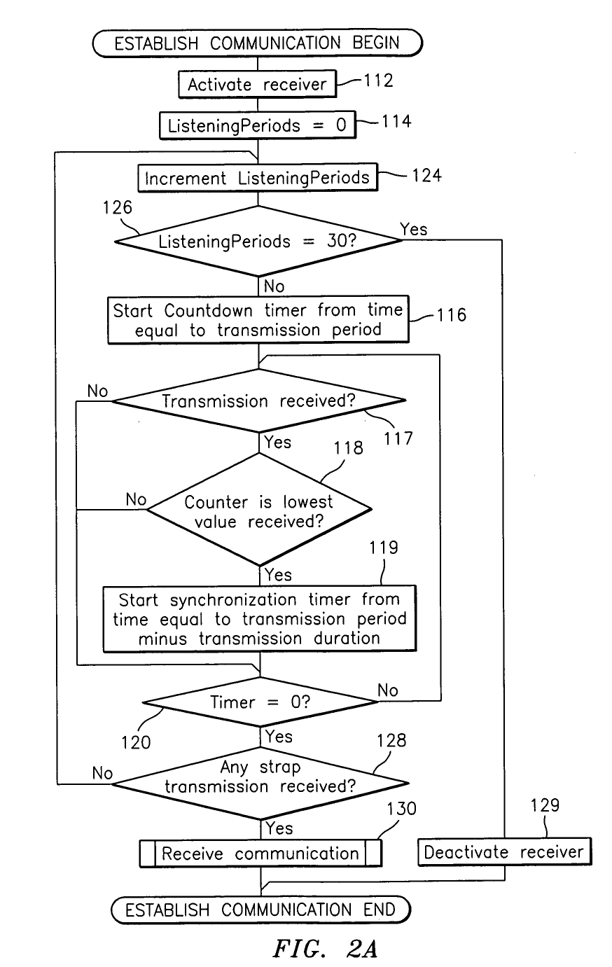

Reference will now be made to FIG. 2A for a detailed description of the foregoing.

Here again, the preferred method of synchronization begins with a listening period, wherein the receiving device will “listen” for one or more transmitting devices. The initial steps in this methodology preferably comprise activating the receiving device to its “listening mode” (step 112) and initializing the listening period counter (step 114). Likewise, the ordering of the foregoing steps is not material to the present invention.

During the first listening period, the receiving unit will start a timer (step 116), which can be either a count-up or count-down timer (in the preferred embodiment the timer is a count-down timer), the duration of which is preferably equal to the expected transmission period between transmissions of packets of information in accordance with the preferred protocol set forth above, namely two (2) seconds. During this two (2) second period, the receiving device will “listen” for any and all the transmitting devices it is capable (e.g. signal strength) of hearing, while adhering to the protocol to be hereinafter disclosed.

In step 117, it is determined if a packet of information from a transmitting device is received and if so, a decision step follows to determine if the count value associated with the just received packet of information is the lowest count value having been received (step 118). As with the first embodiment, the receiving device keeps track of all the count values associated with each respective packet of information it receives and processes. If the count value associated with the packet of information is the lowest count value received, a synchronization timer is started (step 119). This synchronization timer has a duration of time equal to the transmission period minus the transmission duration in order to initiate synchronization with the transmitting device which was determined to be most recently activated. It is also determined if this second transmitter has been active for a shorter period of time than the previous (e.g. first) transmitting device (i.e. steps 117, 118). This loop (i.e. steps 117, 118, 119) continues until the countdown timer commenced in step 116 expires (step 120). In other words, prior to the expiration of the synchronization timer, each time a transmitting device is heard by the receiving device and determined (i.e. from its count value) to have been active for the shortest period of time, the synchronization timer is reset to initiate synchronization with the transmitting device determined to have been most recently activated. In this way, the synchronization timer is reset each time a lower (or higher in the event a high value is indicative of the shortest period of time) count value is received thus providing essentially one transmission period (from the last (and most recently active) transmitting device) within which the receiving device may hear yet a more recently activated transmitting device.

Importantly, it can thus be seen that step 119 initiates synchronization with the most recently activated transmitting device.

On the other hand, if it is determined that no other packets of information received prior to receiving a second packet of information from the second (i.e. most recently activated) transmitting device has a value indicative of a transmitting device having been active for a shorter period of time than the second transmitting device, the methodology maintains synchronization (step 130) of the receiving device with the proper (e.g. second) transmitting device.

It should thus be understood that if, prior to receiving a second packet of information from the first transmitting device, the receiving device receives a first packet of information from the second transmitting device and determines that the second transmitter has been active for a period of time longer than the first transmitting device; and it is determined that no other packets of information received prior to receiving a second packet of information from the first transmitting device has a value indicative of a transmitting device having been active for a shorter period of time than the first transmitting device, the methodology ensures that the receiving device maintains synchronization with the first transmitting device.

Similar to the first embodiment, this second embodiment is likewise flexible enough to accommodate more than two transmitting devices. For example, from a review of FIG. 2A it can be seen that the methodology takes into account the example whereby during the first transmission period, the receiving device receives a first packet of information transmitted from a first transmitting device and prior to receiving a second packet of information from the first transmitting device, the receiving device receives a first packet of information from a second transmitting device and determines that the second transmitter (i.e. transmitting device) has been active for a shorter period of time than the first transmitting device (which results in the receiving device initiating synchronization with the second transmitting device). However, prior to receiving a second packet of information from the second transmitting device, a first packet of information from yet a third transmitting device is received and it is determined that this third transmitter has been active for a shorter period of time than the second transmitting device. In the case where no other packets of information received prior to receiving a second packet of information from the third transmitting device has a value indicative of a transmitting device having been active for a shorter period of time than the third transmitting device, the receiving device will maintain synchronization with the third transmitting device. Clearly then, more than three transmitting devices can be accommodated since the methodology at steps 117, 118, 119 provide for the continuous checking, prior to receiving another packet from the most recently activated transmitting device, of yet even more recently activated transmitting devices, and provides for the maintaining of synchronization therewith (if applicable).

With whichever transmitting device the receiver maintains synchronization, the maintenance of the synchronization comprises the steps of again starting the synchronization timer to be ready to receive subsequent packets of information from the transmitting device having been determined to be active for the shortest period of time. Reference may thus be made to FIG. 1C, discussed above, for a detailed disclosure thereof.

Likewise, at the end of the first transmission period (i.e. step 124) the receiving device determines if it has received any packets of information from any transmitting device (step 128). If the answer is in the negative, the methodology calls for the incrementing of the “listening period” counter at step 124, and the foregoing process is repeated for another transmission period. If the receiving device does not hear any transmitting devices for the entire listening period (step 128), the preferred method results in the deactivation of the receiving device (step 129) and the termination of the routine.

It can thus be seen that this second embodiment likewise provides a unique and elegant way to ensure the receiver's synchronization with the most recently active (i.e. activated) transmitting device (e.g. with the lowest received count value (or highest in an count down implementation)).

It can thus be seen that the present method overcomes the perceived limitations in the prior art and provides novel arrangements and methodologies for reliably synchronizing companion devices, and in particular a transmitting device and a receiving device, such as a heart rate monitor and wristwom unit, by way of example.

It is also to be understood that the following claims are intended to cover all of the generic and specific features of the invention described herein and all statements of the scope of the invention which as a matter of language might fall therebetween. For example, the transmitter may be transmitting an oxygen level parameter or blood pressure information, just to name a few other applications contemplated and covered hereby.

To be sure, a preferred embodiment herein has been disclosed in connection with incrementing count values. The present invention contemplates, and the claims hereby cover, the embodiment whereby count-down counters are used. Such a construction would be well within the purview of one skilled in the art.

What is claimed is:

1. A method of establishing a communication link between a receiving device and a transmitting device from among a plurality of transmitting devices, wherein each of the transmitting devices comprise a transmitter that respectively transmit packets of information, each packet of information comprising a value that is indicative of how long the particular transmitter device has been active, and wherein the receiving device receives transmitted packets of information from one or more of the transmitting devices and processes the respectively received values, wherein the method comprises the steps of:
receiving, during a first transmission period, a first packet of information transmitted from a first transmitting device;
receiving, during a later transmission period, a second packet of information from a transmitting device and determining from the value transmitted with the second packet of information whether the transmitting device has been active for no longer a period of time than the transmitting device from which the first packet of information was received during the first transmission period; and
if so, synchronizing the receiving device with the transmitting device that transmitted the second packet of information.

2. The method as claimed in claim 1, wherein the second packet of information is transmitted from the first transmitting device and the receiving device synchronizes with the first transmitting device.

3. A method of establishing a communication link between a receiving device and a transmitting device from among at least a first transmitting device and a second transmitting device, wherein each of the first and second transmitting devices comprise a transmitter that respectively transmit packets of information, each packet of information comprising a value that is indicative of how long the particular transmitting device has been active, and wherein the receiving device receives transmitted packets of information from at least the first and second transmitting devices and processes the respectively received values, wherein the method comprises the steps of:
receiving, during a first transmission period, a first packet of information transmitted from the first transmitting device and a first packet of information from the second transmitting device and maintaining the value associated with the transmitting device that has been active for the shortest period of time;
receiving, during a later transmission period, a packet of information from one or more transmitting devices; and
determining, from the respective values transmitted with the packets of information from the one or more transmitting devices during the later transmission period, which transmitting device from those transmitting devices for which packets of information have been received and processed, has been active for the shortest period of time; and
synchronizing the receiving device with the transmitting device that transmitted the packet of information with the value indicative of having been active for the shortest period of time.

4. The method as claimed in claim 3, wherein it is the second transmitting device that transmitted, during the later transmission period, the packet of information with the value indicative of having been active for the shortest period of time.

5. The method as claimed in claim 3, wherein it is the first transmitting device that transmitted, during the later transmission period, the packet of information with the value indicative of having been active for the shortest period of time.

6. The method as claimed in claim 3, including the step of inhibiting the synchronization of the receiving device with any transmitting device that has a respective value indicative of a transmitting device that has been active for longer than the transmitting device determined to have been active for the shortest period of time.

7. The method as claimed in claim 3, wherein the later transmission period is a subsequent transmission period to the first transmission period.

8. The method as claimed in claim 1, wherein each packet of information comprises a count value, and wherein each successively transmitted packet of information from a particular transmitter has a count value that is greater than the count value associated with a previously transmitted packet of information from the particular transmitter, wherein the method comprises the steps of:
during the later transmission period, determining whether the count value transmitted with the second packet of information is less than or equal to an incremented value of the count value transmitted with the first packet of information; and
if so, synchronizing the receiving device with the transmitting device that transmitted the second packet of information.

9. The method as claimed in claim 3, wherein each packet of information transmitted by a transmitting device comprises a count value and wherein each successively transmitted packet of information from the transmitter of a transmitting device has a count value that is greater than the count value associated with a previously transmitted packet of information from the respective transmitting device, wherein the method comprises the steps of:
during the first transmission period, maintaining the lowest count value determined from the count value associated with the first packet of information transmitted from the first transmitting device and the first packet of information transmitted from the second transmitting device; and
determining whether the count value transmitted with the packet of information from the transmitting device during the later transmission period is less than or equal to an incremented value of the maintained count value; and
if so, synchronizing the receiving device with the transmitting device that transmitted the packet of information during the later transmission period.

10. The method as claimed in claim 9, wherein during the later transmission period, if the receiving device processes a second packet of information transmitted by the first transmitting device and determines that the count value associated with the second packet of information is greater than the incremented value of the maintained count value, then the method comprises the steps of:
processing a second packet of information transmitted by the second transmitting device and determining whether the count value associated with the second packet of information from the second transmitting device is lower than or equal to the incremented value of the maintained count value; and
if so, synchronizing the receiving device with the second transmitting device.

11. The method as claimed in claim 9, wherein during the later transmission period, if the receiving device processes a second packet of information transmitted by the first transmitting device and determines that the count value associated with the second packet of information is less than or equal to the incremented value of the maintained count value, then the method comprises the steps of:
synchronizing the receiving device with the first transmitting device.

12. The method as claimed in claim 9, wherein during the later transmission period, if the receiving device does not process a packet of information having a count value less than or equal to the incremented value of the maintained count value, then the method comprises the steps of:
inhibiting the synchronization of the receiving device with either of the first or second transmitting device during the later transmission period.

13. The method as claimed in claim 9, including the step of inhibiting the synchronization of the receiving device with any transmitting device that has a respective count value indicative of a transmitting device that has been active for longer than the transmitting device determined to have been active for the shortest period of time.

14. The method as claimed in claim 9, wherein the later transmission period is a subsequent transmission period to the first transmission period.

15. A method of establishing a communication link between a receiving device and a transmitting device from among a first transmitting device and at least a second transmitting device, wherein each of the transmitting devices comprise a transmitter that respectively transmit packets of information, each packet of information comprising a value that is indicative of how long the particular transmitter device has been active, and wherein the receiving device receives transmitted packets of information from at least the first and second transmitting devices and processes the respectively received values, wherein the method comprises the steps of:
receiving respective first packets of information transmitted from the first and at least second transmitting devices;
determining from the values transmitted with the respective first packets of information which transmitting device has been active for the shortest period of time; and
maintaining synchronization of the receiving device with the transmitting device determined to have been active for the shortest period of time.

16. The method as claimed in claim 15, including the steps of:
receiving, during a predetermined transmission period, a first packet of information transmitted from the first transmitting device;
receiving, but prior to receiving a second packet of information from the first transmitting device, a first packet of information from the second transmitting device and determining that the second transmitter has been active for a shorter period of time than the first transmitting device;
determining that no other packets of information received prior to receiving a second packet of information from the second transmitting device has a value indicative of a transmitting device having been active for a shorter period of time than the second transmitting device; and
maintaining synchronization of the receiving device with the second transmitting device.

17. The method as claimed in claim 15, including the steps of:
receiving, during a predetermined transmission period, a first packet of information transmitted from the first transmitting device;
receiving, but prior to receiving a second packet of information from the first transmitting device, a first packet of information from the second transmitting device and determining that the second transmitter has been active for a period of time longer than the first transmitting device;
determining that no other packets of information received prior to receiving a second packet of information from the first transmitting device has a value indicative of a transmitting device having been active for a shorter period of time than the first transmitting device; and
maintaining synchronization of the receiving device with the first transmitting device.

18. The method as claimed in claim 15, including the steps of:
receiving, during a predetermined transmission period, a first packet of information transmitted from the first transmitting device;
receiving, but prior to receiving a second packet of information from the first transmitting device, a first packet of information from the second transmitting device and determining that the second transmitter has been active for a shorter period of time than the first transmitting device;
receiving, but prior to receiving a second packet of information from the second transmitting device, a first packet of information from a third transmitting device and determining if the third transmitter has been active for a shorter period of time than the second transmitting device; and if so
determining that no other packets of information received prior to receiving a second packet of information from the third transmitting device has a value indicative of a transmitting device having been active for a shorter period of time than the third transmitting device; and
maintaining synchronization of the receiving device with the third transmitting device.

19. The method as claimed in claim 15, wherein the maintaining of synchronization comprises the steps of starting the synchronization timer to be ready to receive subsequent packets of information from the transmitting device having been determined to be active for the shortest period of time.

20. The method as claimed in claim 15, including the step of synchronizing the receiving device with the transmitting device that has been active for the shortest period of time.

21. The method as claimed in claim 20, wherein the synchronization step is initiated after each determination that a value associated with a packet of information from a transmitting device is indicative of that transmitting device having been active for the shortest amount of time.
